(19) United States
(12) Patent Application Publication
(10) Pub. No.: US 2009/0110502 A1
(43) Pub. Date: Apr. 30, 2009

(54) Multi function attachment for a drill

(76) Inventor: Paul Rober Brooks, Corry, PA (US)

Correspondence Address: THE INVENTORS NETWORK, INC., 332 ACADEMY STREET, CARNEGIE, PA, 15106, US

(21) Appl. No.: 11/978,040

(22) Filed: Oct. 29, 2007

(51) Int. Cl. B23B 51/00; B01F 7/18

(52) U.S. Cl. 408/227; 366/343; 408/241 R

(57) ABSTRACT

A multi function attachment for a drill for use in building, construction, gardening, yard work, camping, and cooking activities that involve mixing, digging, churning, and stirring includes an elongated shaft securable to the receiving end of the drill, a safety handle slidably disposed upon the shaft and whose slidable movement is delimited by the receiving end of the drill and a handle stop fixedly mounted adjacent the distal end of the shaft, and a digger/mixer member mounted to the distal end of the shaft with the digger/mixer member including a plurality of fingers that project transverse to the axis of the shaft that engage the material, such as dirt or food items, to be dug up, churned, stirred, or mixed upon actuation of the drill.

### FIELD OF THE INVENTION

The present invention pertains to attachments and accessories for tools, and more particularly pertains to an attachable and detachable multi function attachment for electric and battery operated drills.

### BACKGROUND OF THE INVENTION

One of the most common and essential work tools is the drill, either electric or battery operated. Found on all construction sites, and in the majority of homes and residences, the drill is an essential tool for do-it-yourselfers, machine shops, auto body shops, contractors, builders, repairman, and handymen. A primary advantage of the contemporary drill is that is accommodates interchangeable attachments at its operational or business end by opening and closing jaws through the action of rotating a sleeve or inserting a chuck key into a key hole and then turning the chuck key. The attachment is inserted into the jaw opening and then the jaws are closed for holding the attachment therein; when a different type or kind or attachment is needed, the jaws are opened, the old attachment is removed and the new attachment is then inserted into the jaw opening whereupon the jaws are closed down upon this attachment thereby fixing the new attachment in position. The most common type of interchangeable attachment is interchangeable drill bits for accommodating the wide range of screws and fasteners currently used in the building, construction, and trades industries. However, drills are not exclusively used for drilling screws and fasteners into materials and substrates; they can also be used for mixing and digging purposes if the appropriate attachment is mounted to the drill. It would be even more desirable if such an attachment combines or incorporates a number of functions thereby obviating the need to constantly change attachments for undertaking various type of work activities. Thus, the prior art discloses a number of digging and drilling attachments for a drill.

For example, the Thomas et al. patent (U.S. Pat. No. 3,444,940) discloses an auger bit for an auger having at least one spiral flight for the blade and the blade defined by a split spiral form.

The Savitski patent (U.S. Pat. No. 5,213,170) discloses a footing auger having a chuck at one end for attaching the auger to the power tool and a hardened blade extension at the opposite working end for removing dirt and other material from the hole.

The Greeley patent (U.S. Pat. No. 4,807,710) discloses an earth auger having a helical multi-flighted blade and a second cutting blade radially extending outwardly from the shaft between two of the helical blade flights.

The Beckner patent (U.S. Pat. No. 5,449,254) discloses a compost aeration tool that includes a spiral blunt pointed cutting element mounted to the distal end of the shaft that is rotatably attached to the hand-held tool.

The Farber patent (U.S. Pat. No. 5,765,437) discloses a compost aerator and monitor that includes a cylindrical helical screw having a sharpened distal end for driving into the compost heap for creating an aeration chamber or core.

The Garcia patent (U.S. Pat. No. 6,119,787) discloses an auger planting tool that includes a spiral wheel and a disc mounted to a shaft for simultaneously cutting into the soil and churning the soil preparatory for planting.

Nonetheless, despite the ingenuity of the above devices, there remains a need for a multi function drill attachment that is easy to attach and detach for various construction, home remodeling and repair, outdoor gardening and yard work, and miscellaneous processes and activities.

### SUMMARY OF THE INVENTION

The present invention comprehends a multi function attachment for a drill for performing activities and uses that range from outdoor yard work and construction operations to indoor activities ranging from painting to cooking. The multi function attachment is easily attachable to and detachable from the receiving end of any drill whether electric powered or battery powered.

The multi function attachment includes an elongated cylindrical shaft having an attachment end for securement to the drill and an opposite use end. A handle stop is fixedly mounted to the shaft adjacent the use end. A safety handle is disposed on the shaft and is capable of slidable movement thereon with the movement delimited by the receiving end of the drill and the handle stop. The safety handle includes a cylindrical tube slidably mounted upon the shaft, a flanged first end and a safety disc mounted at a second end. The individual is able to grasp the cylindrical tube for stabilizing and controlling the rotatable action of the attachment during use with the individual's hand capable of resting upon the safety disc for protection from the operational end of the attachment. The operation end of the attachment is configured to include at least three fingers or prongs extending transverse to the longitudinal axis of the shaft. In the preferred embodiment of the fingers, one finger extends transverse to the axis of the shaft while two fingers extend transverse to the shaft and point or are oriented in the opposite direction with respect to the single extended finger. The fingers rotate concomitant with the rotation of the shaft to facilitate any number of mixing, digging, stirring, churning or circulating actions or processes in substances as varied as dirt, cement, paint, garden potting soil or cooking flour, dough, and other food products.

It is an objective of the present invention to provide a multi function attachment for a drill that can be used for various and diverse activities such as patio gardening, yard work, camping, and mixing substances ranging from pancakes to cement.

It is another objective of the present invention to provide a multi function attachment for a drill that can be used with both electric drills and battery operated drills.

It is yet another objective of the present invention to provide a multi function attachment for a drill that obviates and eliminates the need for employing numerous separate hand held digging and mixing tools and implements.

It is still another objective of the present invention to provide a multi function attachment for a drill that makes labor intensive projects that involve laborious digging and mixing easier and less physically demanding.

It is still yet another objective of the present invention to provide a multi function attachment for a drill wherein the drill can be manufactured from steel for outdoor use and manufactured from plastic for indoor (cooking) use.

Still another objective of the present invention is to provide a multi function attachment for a drill that combines portability, flexibility, and versatility in one multi use tool.

Still yet another objective of the present invention is to provide a multi function attachment for a drill that saves space in a toolbox or for storage in a kitchen by combining in one device numerous work functions.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the multi function attachment for a drill illustrating the attachment being used for mixing cement;

FIG. 2 is a perspective view of the multi function attachment for a drill illustrating the securement of the attachment to the receiving end of the drill;

FIG. 3 is a side elevational view of the multi function attachment for a drill;

FIG. 4 is a front elevational view of the multi function attachment for a drill;

FIG. 5 is a top plan view of the multi function attachment for a drill; and

FIG. 6 is a sectioned elevational view of the multi function attachment for a drill taken along lines 6-6 of FIG. 4.

### DETAILED DESCRIPTION OF THE PREFERRED EMBODIMENT

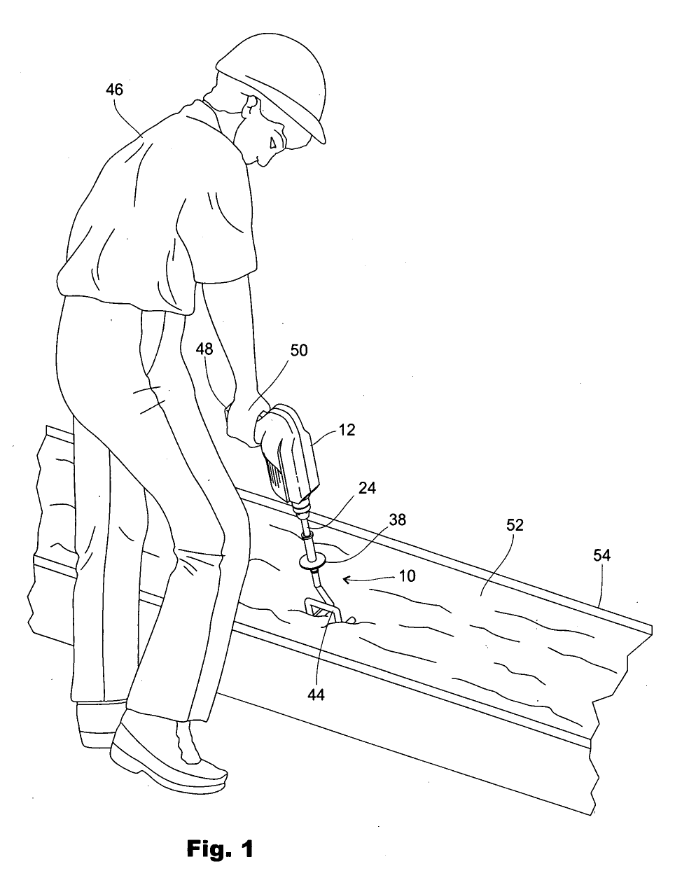

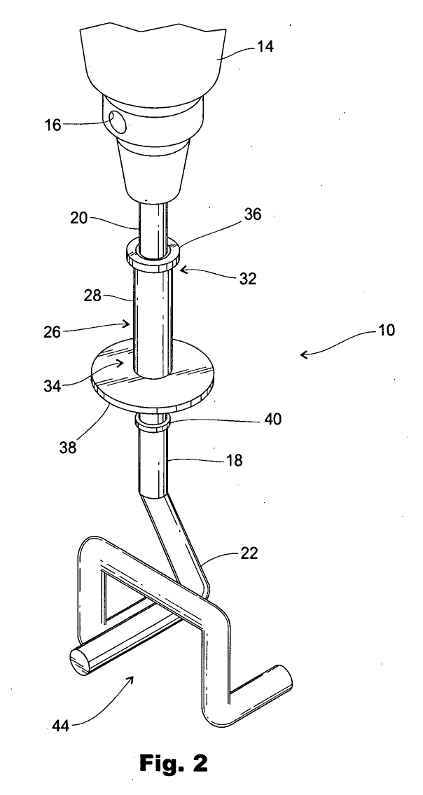

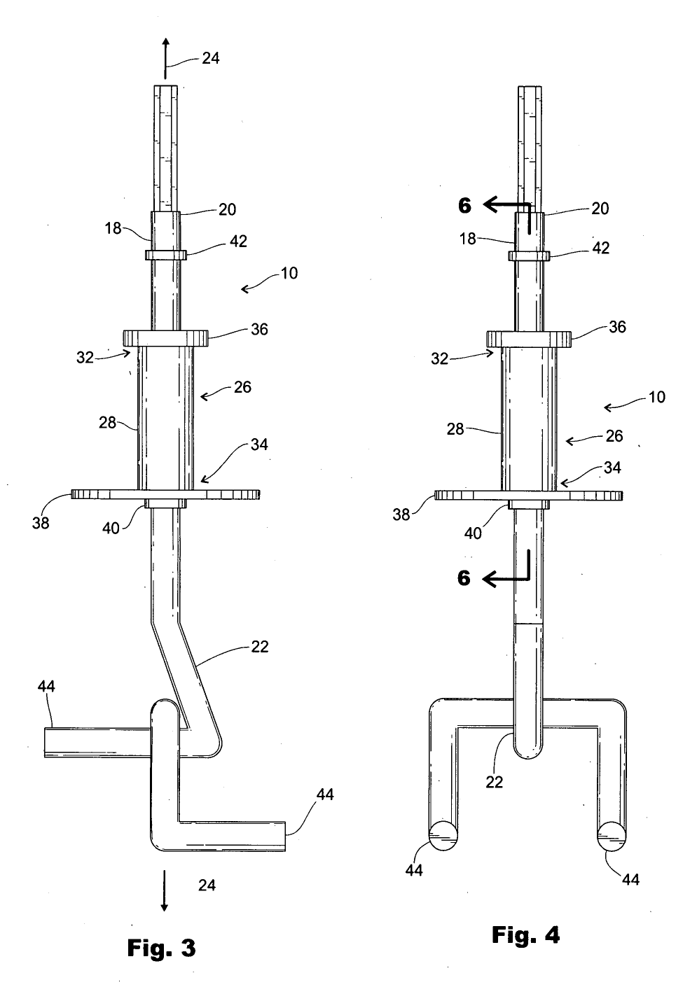

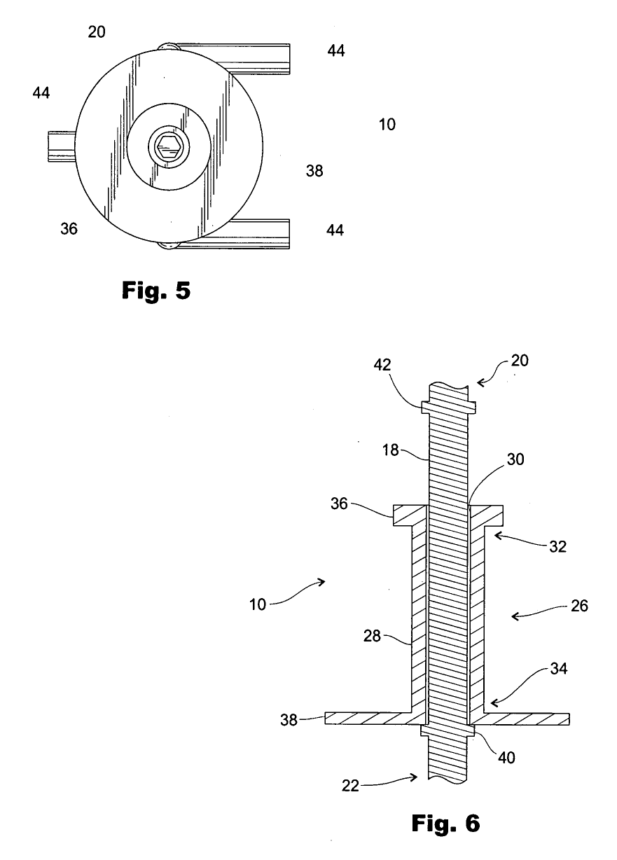

Illustrated in FIGS. 1-6 is a multi function attachment 10 for a drill, such as the representative drill 12 shown in FIG. 1, and which is easily attachable to, and detachable from, the receiving or jaw end 14 of the drill 12 for use in a wide range of work, construction, and home activities or processes. The receiving end 14 of the drill 12 includes elongated jaws that open up for allowing the placement therebetween of a drill bit or the multi function attachment 10 of the present invention, and then close upon the drill bit or multi function attachment 10 by inserting a chuck key (not shown) into a chuck slot or opening 16, and then appropriately rotating the chuck key. Rotating the chuck key clockwise or counterclockwise, as the case may be, causes the jaws—and other structure within the receiving end—to consequently open or close allowing for the interchangeable securement and removal of various kinds of tools, implements, and drill bits to the drill including the multi function attachment 10 of the present invention.

Thus, illustrated in FIGS. 1-6 is the multi function attachment 10 for the drill 12 that is money saving, time saving, and less labor intensive for many types of work projects. The multi function attachment 10 includes an elongated shaft 18 having an attachment/securement end 20 that is gripped by and within the receiving end 14 and rotated concomitant with the actuation of the drill 12, and a second distal end 22 that is the operational or work use end. The elongated shaft 18 defines a longitudinal axis 24, and the multi function attachment 10 can be manufactured from steel for predominantly outdoor work—dirt work in gardens and yards, cement mixing, etc. —or from a hard, durable, washable plastic for predominantly indoor use such as in mixing, stirring, and churning food products and substances as part of cooking and meal preparation.

Slidably mounted upon the elongated shaft 18 is a safety handle 26, and the safety handle 26 includes a cylindrical tubular member 28 having an elongated chamber or passageway 30 coextensive with the tubular member 28 through which a portion of the length of the shaft 18 extends. The safety handle 26 also includes a first inner end 32 and an opposite second end 34, and fixedly mounted to the tubular member 28 at the first inner end 32 is a flange 36 while fixedly mounted to the tubular member 28 at the second end 34 is a safety disc 38 whose diameter is substantially greater than and exceeds the diameter of the flange 36. A handle stop 40 is fixedly secured to the shaft 18 adjacent the distal operational end 22 of the shaft 18, and the reciprocable slidable movement of the safety handle 26 upon the shaft 18 is delimited by and between the handle stop 40 and the receiving or jaw end 14 of the drill 12; thus, the safety handle 26 is able to slide between the handle stop 40 and the receiving end 14 of the drill 12. In addition, a second safety handle stop 42, as shown in FIGS. 4 and 6, can be added to further delimit the slidable movement of the safety handle 26 upon the shaft 18.

As shown in FIGS. 1-6, the working or operational end 22 of the shaft 18 of the multi function attachment 10 includes a digger/mixer means integrally formed, attached, or mounted thereto for engaging and contacting the substance, such as a food product, dirt, fertilizer, cement, paint, etc., that is to be dug up, churned, mixed, or stirred. In the present invention the digger and mixer means mounted to the operational end 22 of the shaft 18 includes a plurality of fingers or prongs 44 with all of the fingers or prongs 44 extending laterally and transverse to the longitudinal axis 24 of the shaft 18. The preferred embodiment of the present invention includes three fingers 44 with two fingers 44 spaced from each other and extending laterally in one direction and a single finger 44 extending laterally and in the direction opposite—180 degrees—from the two first mentioned spaced apart fingers 44. However, it should be noted that more than three fingers or prongs 44 could be employed, with the additional fingers 44 laterally projecting from the working end 20 of the shaft 18 at orientations or angles that could be 45 degrees, 90 degrees, or any intermediate degree from the three fingers 44 shown in FIGS. 1-6 of the presently preferred embodiment.

In operation the multi function attachment 10 would be secured to the receiving end 14 of the drill 12 by inserting the attachment end 20 of the shaft 18 between and within the open jaws or other structure and then tightly and securely closing the receiving end 14 upon the attachment end 20 of the shaft 18. Actuation of the drill 12 will then cause the entire shaft 18, including the fingers 44 that comprise the digger and mixer means, to also rotate. One of the numerous ways the multi function attachment 10 can be used is shown by way of example in FIG. 1. In FIG. 1 the individual 46 is holding the frame grip 48 of the drill 12 by one hand 50 while the other hand 50 is free to grasp the safety handle 26 for stabilizing and controlling the rotational action of the drill 12 and the fingers 44. The fingers 44 at the end 22 of the shaft 18 are inserted or placed into the substance to be mixed, dug, churned or stirred, which, in FIG. 1 is cement 52 contained within a trough 54. The rotational and stirring action of the fingers 44 within the cement 52 is continued as long as needed, and then the individual 46 can withdraw the fingers 44 from the substance or material, for either repeating the above actions as needed, or for easily and quickly detaching the multi function attachment 10 from the drill 12 so that a different implement or tool can be secured to the drill 12.

The foregoing detailed description is to be clearly understood as given by way of example and illustration only, and any modifications, alterations, and variations possible and practicable to those skilled in the art may be made and yet remain within the spirit of the invention and the scope of the claims appended hereto and their equivalents.

I claim:

1. A multi function attachment for a drill, comprising:
an elongated shaft having an attachment end for attachment to the drill and an opposite second distal end and the shaft defining a longitudinal axis;
a handle stop mounted on the shaft adjacent the second distal end;
a safety handle mounted on the shaft and capable of slidable reciprocable movement thereon;
the safety handle including a tubular member that slides upon the shaft, and the tubular member including a first inner end and an opposite second end;
a flange mounted on the tubular member at the first inner end;
a safety disc mounted on the tubular member at the second end; and
digger and mixer means integrally mounted to the shaft at the second distal end for mixing, stirring, churning and digging materials and substances.

2. The multi function attachment for a drill of claim 1 wherein the slidable movement of the safety handle on the shaft is delimited by the handle stop and the receiving end of the drill.

3. The multi function attachment for a drill of claim 2 wherein the digger and mixer means includes a plurality of fingers that extend laterally with respect to the longitudinal axis of the shaft.

4. The multi function attachment for a drill of claim 3 further comprising a second safety handle stop mounted to the shaft adjacent the second distal end thereof.

5. A multi function attachment for a drill, comprising:
an elongated shaft having an attachment end for attachment to the drill and an opposite second distal end and the shaft defining a longitudinal axis;
a handle stop mounted on the shaft adjacent the second distal end;
a safety handle mounted on the shaft and capable of slidable reciprocable movement thereon;
the safety handle including a tubular member that slides upon the shaft, and the tubular member including a first inner end and an opposite second end;
a flange mounted on the tubular member at the first inner end;
a safety disc mounted on the tubular member at the second end; and
a plurality of fingers mounted to the shaft at the second distal end with the fingers laterally extending from the longitudinal axis of the shaft and the fingers capable of mixing, stirring, churning, and digging substances and materials upon the rotation of the shaft by the actuation of the drill.

6. The multi function attachment for a drill of claim 5 wherein the slidable movement of the safety handle on the shaft is delimited by the handle stop and the receiving end of the drill.

7. The multi function attachment for a drill of claim 6 further comprising a second safety handle stop mounted to the shaft adjacent the attachment end of the shaft.
